(19) United States
(12) Patent Application Publication
(10) Pub. No.: US 2007/0066315 A1
(43) Pub. Date: Mar. 22, 2007

(54) Method of setting a path suitable for a wireless mesh network using an evaluation parameter

(75) Inventor: Youiti Kado, Kyoto (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/516,628

(22) Filed: Sep. 7, 2006

(30) Foreign Application Priority Data
Sep. 8, 2005 (JP) 2005-261159

(51) Int. Cl. H04J 3/24

(52) U.S. Cl. 455/445; 370/349

(57) ABSTRACT

A network path setting method sets a path of a session specified in a wireless mesh network including wireless stations, two of the wireless stations being defined as one end and the other end of the session. First, one or more potential paths are obtained for the session based on the number of hops. When a plurality of potential paths are obtained, wireless resource consumption is calculated for each potential path, or a traffic margin of each potential path is calculated according to the traffic margin of a relaying wireless station. The calculated wireless resource consumption or traffic margin of the potential paths is used as an evaluation parameter to select and set the path of the session. Among a number of connection paths, a connection path is selected which is suitable for the entire network.

### BACK GROUND OF THE INVENTION

1. Field of the Invention

The present invention relates to a network path setting method and a wireless station, and more specifically to a network path setting method and a wireless station applicable to a wireless communications system, for example, having a number of connection paths provided for a service such as a wireless IP (Internet Protocol) phone.

2. Description of the Background Art

The wireless network having a number of connection paths is referred to, by different names from different points of view, as wireless multi-hop communications network, wireless ad hoc network and wireless mesh network. It will hereinafter be referred to generally as a wireless mesh network. It is desired in the wireless mesh network to select the optimum connection path from the number of connection paths.

U.S. patent application publication No. 2003/0091001 A1 to Watanabe discloses a conventional method for quickly searching for the optimum path for communication. The method uses, as an indicator in selecting the path in a wireless mesh network, weighting so that the bit error rate and data transfer rate of a link are reflected, where a link is a connection performed between nodes in one transmitting and receiving processing, and is referred to as a communication path in Watanabe.

The conventional technology, however, did not seek to achieve optimization across an entire path in the wireless mesh network. For example, the above-mentioned method discloses, in a layer that establishes a link, a weighting calculation method according to the bit error rate and transfer rate, a weighting calculation method taking account of an actual transfer delay, and an optimum route determination method using the weightings resulting from the above calculation methods. The weighting taking account of a transfer delay provides, however, greater weighting for a larger delay path and an extensive value added to the weighting, thereby making it more difficult to select that path.

A path having its bit error rate lower is not necessarily totally optimum. A path having its transfer delay lower is not necessarily totally optimum. For example, when some of the wireless resources have shorter queues, an attempt to achieve the total optimum of the wireless mesh network due to the wireless resources being short would require measures for minimizing the cost incurred on the entire network by a route selected.

### SUMMARY OF THE INVENTION

Accordingly, it is an object of the present invention to provide a network path setting method and a wireless station that may select one of a number of connection paths which is suitable for an entire network.

The present invention provides a method for setting a path of a session specified in a wireless mesh network including a plurality of wireless stations, two of the wireless stations being defined as one end and the other end of the session, the method comprising the steps of: obtaining one or more potential paths for the session based on the number of hops; calculating, when a plurality of potential paths are obtained, wireless resource consumption for each potential path; and using the calculated wireless resource consumption as an evaluation parameter to select and set the path of the session.

The present invention also provides a method for setting a path of a session specified in a wireless mesh network including a plurality of wireless stations, two of the wireless stations being defined as one end and the other end of the session, the method comprising the steps of: obtaining one or more potential paths for the session based on the number of hops; calculating, when a plurality of potential paths are obtained, the traffic margin of a potential path for each potential path according to the traffic margin of a relaying wireless station; and using the calculated traffic margin of the potential path as an evaluation parameter to select and set the path of the session.

The present invention also provides a method for setting a path of a session specified in a wireless mesh network including a plurality of wireless stations, two of the wireless stations being defined as one end and the other end of the session, the method comprising the steps of: obtaining one or more potential paths for the session based on the number of hops; calculating, for a plurality of potential paths obtained, wireless resource consumption for each potential path and the traffic margin of a potential path for each potential path according to the traffic margin of a relaying wireless station; and using the calculated wireless resource consumption and traffic margin of the potential paths as evaluation parameters to select and set the path of the session.

The present invention also provides a wireless station included in a wireless mesh network, comprising a path setting circuit that performs any of the network path setting methods stated above.

In accordance with the present invention, for a plurality of potential paths existing for a session, wireless resource consumption and/or the traffic margin of each potential path are/is calculated for the potential path, and the calculated wireless resource consumption and/or the traffic margin of the potential paths are/is used as an evaluation parameter or parameters to select the path of the session, whereby a connection path can be selected which is suitable for the entire network.

### BRIEF DESCRIPTION OF THE DRAWINGS

The objects and features of the present invention will become more apparent from consideration of the following detailed description taken in conjunction with the accompanying drawings in which:

FIG. 1 is a flowchart of setting a session path according to an embodiment of the present invention;

FIG. 2 is a schematic block diagram showing a configuration of a wireless station according to the embodiment of the present invention;

FIG. 3 schematically shows an exemplified configuration of a wireless mesh network to which the embodiment is applied;

FIG. 4 illustrates characteristic values measured for the wireless stations shown in FIG. 3;

FIG. 5 illustrates transfer rates for the links shown in FIG. 3;

FIG. 6 illustrates an example of a session requested for the wireless mesh network shown in FIG. 3; and

FIG. 7 illustrates parameters for setting paths with respect to potential paths of the session shown in FIG. 6.

### DESCRIPTION OF THE PREFERRED EMBODIMENT

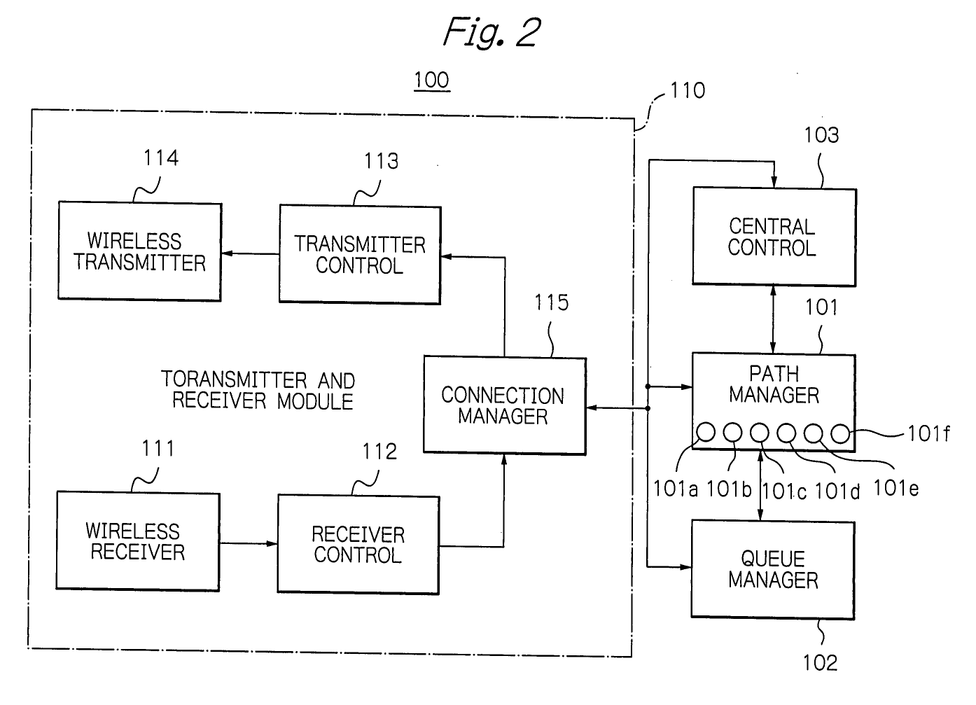

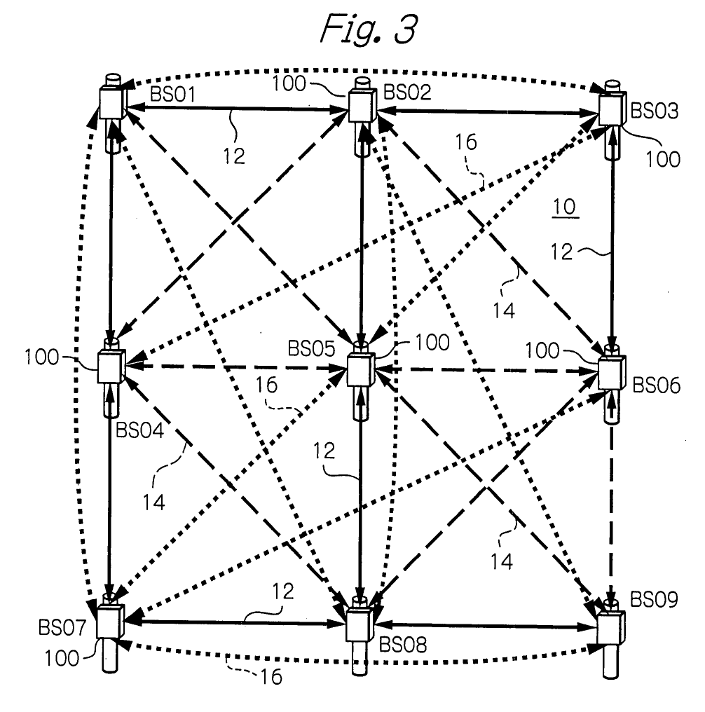

With reference to the accompanying drawings, a more detailed description will be given below on an embodiment of the network path setting method and wireless station according to the present invention. First, reference is made to FIG. 2, which is a schematic block diagram showing the basic configuration of one of wireless stations 100 forming a wireless mesh network 10, FIG. 3, according to an embodiment of the present invention. The wireless stations 100 may be of the same configuration.

Referring to FIG. 2, the wireless station 100 includes a path manager 101, a queue manager 102, a central control 103, and a transmitter and receiver module 110, which are interconnected as illustrated. The path manager 101, queue manager 102, and central control 103 may be implemented by, for example, a CPU (Central Processor Unit), a ROM (Read-Only Memory), a RAM (Random Access Memory), an EEPROM (Electrically Erasable Programmable ROM) or the like, and may process in software. The transmitter and receiver module 110 includes a wireless receiver 111, a receiver control 112, a transmitter control 113, a wireless transmitter 114, and a connection manager 115, which are interconnected as illustrated.

The wireless transmitter 114 functions as transmitting wireless signals. The wireless receiver 111 functions as receiving wireless signals. Any suitable wireless communications method may be applied to the illustrative embodiment.

The receiver control 112 is adapted to extract a packet from a received wireless signal, and then inform the central control 103 via the connection manager 115 of the reception of packets. The receiver control 112 is adapted to be responsive to an instruction from the central control 103 to provide the received packet via the connection manager 115 to the central control 103 and/or queue manager 102. The wireless station 100 may be adapted to provide a packet received to be relayed via the connection manager 115 directly to the transmitter control 113.

The transmitter control 113 serves as generating or updating management information such as a destination or the number of hops to be included in the packet, and converting packets to a wireless or radio wave signal. Packets to be transmitted are provided by the central control 103 or queue manager 102.

The connection manager 115 performs a wireless media access control such as CSMA/CA (Carrier Sense Multiple Access with Collision Avoidance). The connection manager 115 manages the signal input from the receiver control 112 and the transmission instruction from the central control 103, and switches the transmitting and receiving.

The path manager 101 manages information including information for a single hop link from itself (such as the address of a wireless station to be linked, a transfer rate and the latest communication time), multi-hop path information (such as the address of a wireless station to be connected, the address a wireless station to be hopped next, the number of hops and the number of remaining hops), other link information on the network, and load information on other wireless stations. The path manager 101 also holds information necessary for path selection.

The path manager 101 in this embodiment also holds information as described below, and selects a path in the manner as described below. From the viewpoint of selecting paths, the path manager 101 includes, as components for selecting paths, a selector 101a for selecting a plurality of potential paths or candidates, a calculator 101b for calculating an expected delay, a removing portion 101c for removing paths not satisfying the delay condition, a calculator 101d for calculating wireless resource consumption, a calculator 101e for calculating a traffic margin, and a path selector 101f.

The queue manager 102 serves as holding a packet to be relayed and a packet assembled in the wireless station 100, and responding to an instruction from the central control 103 to pass the packets in sequence to the transmitter and receiver module 110.

The central control 103 is an overall controller for controlling the portions and elements described above. The central control 103 works with an information processor or the like, not shown, associated with the wireless station 100.

A description will now be given to the path setting operation by the wireless station 100 in the illustrative embodiment. Generally, in links between wireless stations, or nodes, in a wireless mesh network of the same segment, an optimum transfer rate is set automatically through the negotiation on the physical layer. For example, the existing wireless cards adhering to IEEE (Institute of Electrical and Electronics Engineers) 802.11 b/g or the like has such a setting function. This can confirm how much the transfer rate is set on each link.

Each node in the wireless mesh network as described above measures the load of the queue processing in the form of, for example, the current queue length x average packet transfer interval.

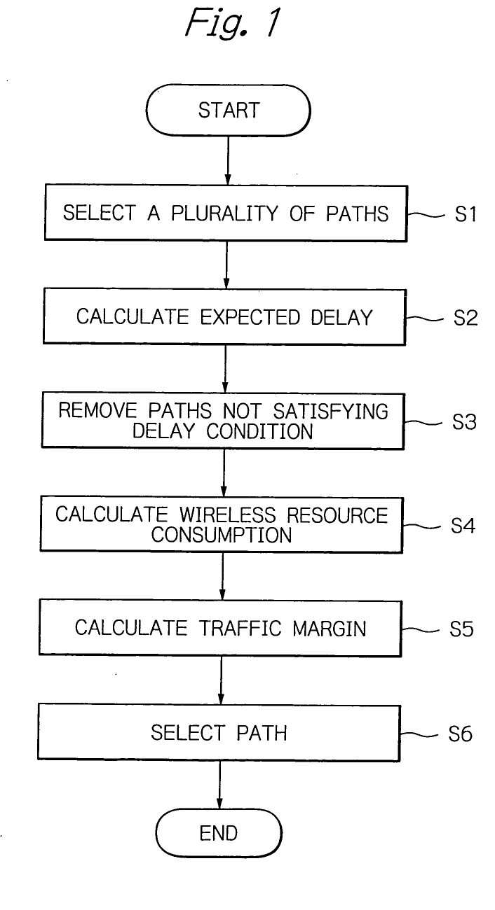

Reference will be made to FIG. 1, which is useful for understanding a path setting operation performed on an end-to-end session by the path manager 101 in response to a path setting request involving an instruction on the call quality, such as packet size, throughput and delay.

In step S1, for a session for which the pass setting is requested, a plurality of paths corresponding to the minimum number of hops are selected as potential paths from end to end.

In step S2, with the packet data size and throughput condition in the instructed call quality being satisfied, an expected delay from end to end is calculated based on the transfer rate on each link and queue load at each node. In expectation that the load of the queue processing will increase after a session is added, an adequate margin is set so as to estimate a heavier load. It is to be note that the margin may have its length fixed because the added session has its traffic amount sufficiently smaller than the capacity of the entire network.

The expected delay time is equal to the total of the link transfer time on the links in a potential path in question plus the total of the packet processing time and average queue-passing time at the nodes in the potential path in question. The link transfer time per link and the in-node packet processing time per node may be omitted from the calculation because they are negligibly smaller than the average queue-passing time elapsed since the packet reaches the node until the packet leaves the node. In this case, the expected delay time can be expressed as:

Expected delay time=Σ(average queue-passing time at a node), where the summation is made on the nodes of interest.

In step S3, one or ones of the plurality of potential paths are deleted or excluded which has or have an expected delay time not satisfying the delay condition of the instructed communication quality.

In steps S4 and S5, a node having its queue extremely long may make it difficult to ensure the call quality of a session that needs to pass through that node. In order to keep the wireless resource consumption as well as the queue-passing time at each node less than or equal to a reference, it is thus necessary to suppress the traffic concentration on some of the nodes. It is thus needed to calculate the wireless resource consumption and traffic margin.

A wireless resource consumption is applied that is expressed by the total of the link transfer times with the signal collision ratio taken into account. The wireless resource consumption can be calculated from the following expression, for example:

Wireless resource consumption [time]=Σ(((data size+header size)/link transfer rate+transfer overhead time)×Σ(1+signal collision ratio))/packet transmission interval, where the former summation is made over all links in a potential path of interest, and the latter summation is on the nodes at both ends of a link of interest.

The margin of conveyable traffic, of which the value ranges from zero to one inclusive, for example, of a node on a path may be applied that is expressed by multiplication of the conveyable traffic margin at all the relay nodes or by the minimum of the margin conveyable traffic at all the relay nodes. In the detailed description of the operation which will be made below, the latter type of conveyable traffic margin is applied.

In step S6, among the potential paths satisfying the communication quality that are not deleted in the step S3, selected is a path that has its margin of the queue on the path larger and its wireless resource consumption smaller. The session setting may thus add the lowest load to the network, thereby providing the largest traffic capacity of the entire network.

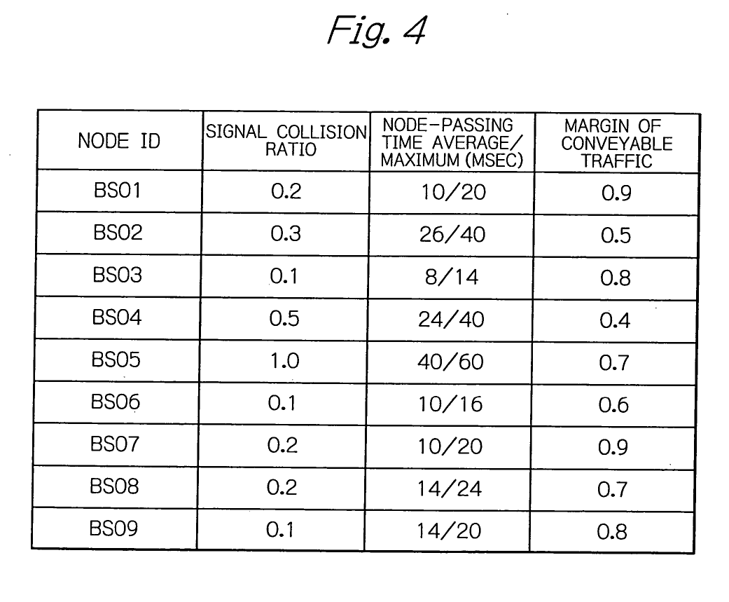

By the aid of specific examples, a description will be given below on the path setting operation in the illustrative embodiment. Referring now to FIG. 3, consider now a wireless mesh network 10 that has the nodes or wireless stations with node identification (ID) ranging from BS01 to BS09, inclusive, allotted, and may provide communications between the nodes over the links shown in the figure. For each of the nodes BS01 through BS09, measured are the signal collision ratio or rate, the average and maximum times necessary for processing a packet that passes through the node, and the margin of conveyable traffic. Information on the measurements is shared by the nodes BS01 through BS09. Suppose that measurements are what are shown in FIG. 4.

The signal collision ratio is represented by, for example, the ratio of the number of attempted signal transmissions to the number of actually failed transmissions that are recognized by the connection manager 115, at a node of interest in a predetermined period of time. The signal collision ratio may be held in the path manager 101 of each node and may be transmitted between the nodes by a control packet to allow each node to obtain the ratio of the other nodes.

The average and maximum times necessary for processing packets that pass through a node are, for example, the average and maximum of measured times taken, at a node of interest in a predetermined period of time, since a transmission packet enters the queue under the management of the queue manager 102 until the transmission packet is transmitted by the wireless transmitter 114. The average and maximum times may be held in the path manager 101 of each node and may be transmitted between the nodes by a control packet to allow each node to obtain data of the other nodes. The time may be measured by referencing the system clock of a node to obtain the time when a packet enters the queue and recording the time in the queue manager 102, then using again the system clock, when the packet is transmitted, to obtaining the current time, and then comparing the current time with the previous time which was obtained when the packet enters the queue and has been recorded in the queue manager 102 for that packet. The times thus measured may be held in the path manager 101.

The margin of conveyable traffic at each node is an index indicating a difference of the current traffic amount imposed on a node from a processable traffic amount at that node obtained by e.g. measuring by the path manager 101. The margin of conveyable traffic may be held in the path manager 101 of each node and may be transmitted between the nodes by a control packet to allow each node to obtain the margin of the other nodes. The margin of conveyable traffic may be transmitted between and shared by the nodes by a control packet to allow each node to obtain data on the nodes therearround.

For example, the margin of conveyable traffic of the node may be expressed by either of the following expressions:

Margin of conveyable traffic=(processable traffic amount−current traffic amount)/processable traffic amount, or

Margin of conveyable traffic=(processable traffic amount−current traffic amount)/(processable traffic amount)².

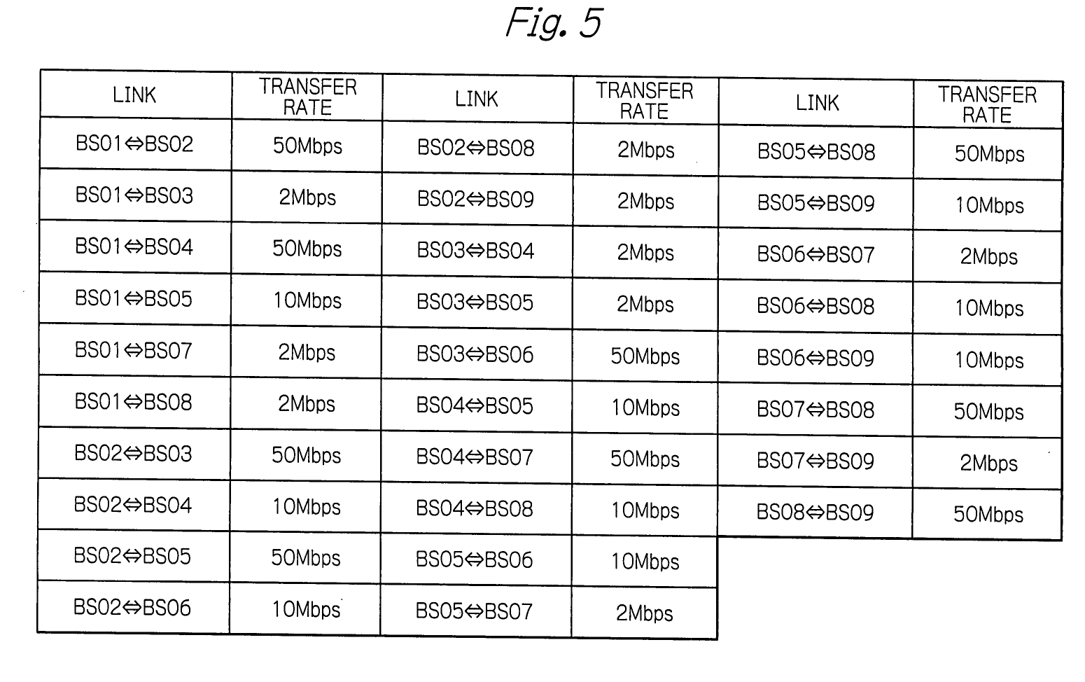

Suppose that data on the transfer rate at the links between the nodes are available as shown in FIG. 5 and shared by those nodes. In FIG. 3, the arrowed solid line links 12 are of a transfer rate of 50 Mbps shown in FIG. 5, the arrowed broken line links 14 are of a transfer rate of 10 Mbps shown in FIG. 5, and the arrowed dotted line links 16 are of a transfer rate of 2 Mbps shown in FIG. 5.

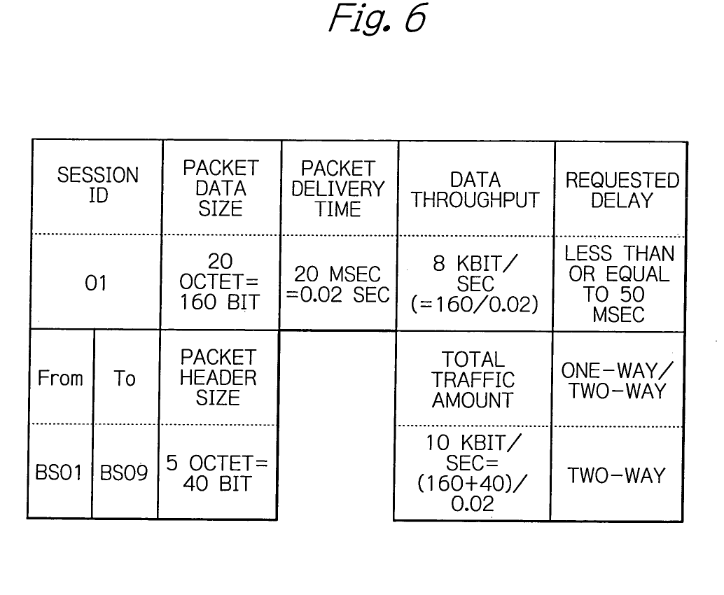

Suppose now that a new session shown in FIG. 6 occurs (session request) when the data and information shown in FIGS. 4 and 5 are held. A description will be given below on the allocation of a path to the session. The path allocation may be performed by, for example, the path manager 101 of the beginning node 100 in the session. Alternatively, it may be managed by the path manager 101 of the end node 100 in the session, the path manager 101 of a dedicated node for the path allocation, or a control station that does not participate in the communication. The following description will be made with assumption that the path manager 101 of any node performs the path allocation regardless of the type of the node.

Although the path allocation or setting is basically performed in the flow shown in and described with reference to FIG. 1, the session request may be confirmed before the operation shown in FIG. 1.

In the session request confirmation, it is confirmed, for example, that request parameters or the like fall within the range accepted by the wireless mesh network 10. The session with its session ID=01 shown in FIG. 6, i.e. session 01, is a two-way traffic between the nodes BS01 and BS09. Session 01 has a delay request of less than or equal to 50 msec.

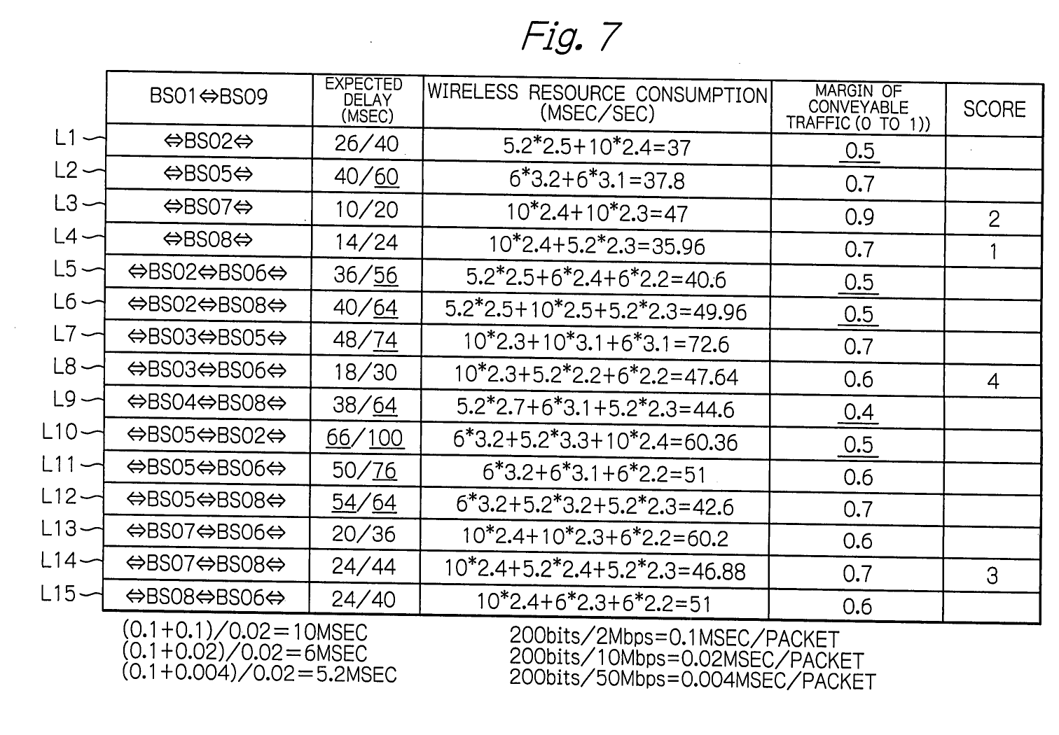

In step S1, FIG. 1, at first, communicable paths or potential paths between the nodes BS01 and BS09 are listed up from the link information. For the node arrangement shown in FIG. 3, for example, fifteen potential paths L1 to L15 are listed up as shown in the first column in FIG. 7. In the example shown in the figure, the transfer overhead is supposed to be 0.1 msec/packet.

In step S2, the average and maximum of the expected delay time are calculated by adding the average and maximum values of the time necessary for processing a packet that passes through a relay node with respect to all the relay nodes. The second column in FIG. 7 shows the average and maximum of the expected delay time in this order that are calculated for each of the potential paths L1 to L15.

The potential path L1, for example, has the node BS02 as a single relay node. Therefore, the average (26 msec) and maximum (40 msec) of the node-passing time of the node BS02 directly form the average (26 msec) and maximum (40 msec) of the expected delay time of the potential path L1. The potential path L5, for example, has the two nodes BS02 and BS06 as relay nodes. Therefore, the addition of the average (26 msec) and maximum (40 msec) of the node-passing time of the node BS02 to the average (10 msec) and maximum (16 msec) of the node-passing time of the node BS06 results in the average (36 msec) and maximum (56 msec) of the expected delay time of the potential path L5.

In step S3, after the expected delay time, particularly, the average and maximum thereof, is determined, it is compared with the requested delay, and the potential paths that do not satisfy the requested delay are removed. The requested delay may also be given in either one or both of its average and maximum.

In respect of the session request shown in FIG. 6, the requested delay value, i.e. delay time, is less than or equal to 50 msec. With this requested delay being considered as the requested delay for the maximum of the expected delay, the maximum values underlined on the right-hand side in the second column from the left in FIG. 7 do not satisfy the requested delay, and the potential paths of those maximums are to be removed. Under the condition, the potential paths L2, L5 to L7, and L9 to L12 are to be removed. With the requested delay value, i.e. delay time, which is less than or equal to 50 msec being considered as the requested delay for the average of the expected delay, the average values underlined on the left-hand side in the second column in FIG. 7 do not satisfy the requested delay, and the potential paths of those averages are to be removed. Under the condition, the potential paths L10 and L12 are to be removed.

In step S4, the wireless resource consumption is calculated for each link on each unremoved potential path. The wireless resource consumption for each unremoved potential path is calculated by adding or summing up the wireless resource consumption for all the links on that path. The transfer overhead is supposed here to be 0.1 msec/packet. The following expression is the same as described earlier, but is modified. The packet length (=data size+header size) is 200 bit, independent of a link. The packet transmission interval is 0.02 second, also independent of a link. Wireless resource consumption [time]=Σ((transfer overhead+packet length/transfer rate)/packet transmission interval×Σ(1+signal collision ratio)). The potential path L1, for example, has a link between the nodes BS01 and BS02 and a link between the nodes BS02 and BS09.

The former link between the nodes BS01 and BS02 has its transfer rate equal to 50 Mbps. The link thus has its value of (packet length/transfer rate) equal to 200 bit/50 Mbps, which is 0.004 msec/packet. The link thus has its value of ((transfer overhead+packet length/transfer rate)/packet transmission interval) equal to (0.1+0.004)/0.02 msec, which is 5.2 msec. The nodes BS01 and BS02 at both ends of the former link have the signal collision ratio thereof equal to 0.2 and 0.3, respectively. The value resultant from the summation, Σ(1+signal collision ratio), is thus (1+0.2)+(1+0.3)=2.5. The former link thus has its wireless resource consumption of 5.2×2.5.

The latter link between the nodes BS02 and BS09 has its transfer rate equal to 2 Mbps. The link thus has its value of (packet length/transfer rate) equal to 200 bit/2 Mbps=0.1 msec/packet. The link thus has its value of ((transfer overhead+packet length/transfer rate)/packet transmission interval) equal to (0.1+0.1)/0.02=10 msec. The nodes BS02 and BS09 at both ends of the latter link have the signal collision ratio thereof equal to 0.3 and 0.1, respectively. The summation, Σ(1+signal collision ratio), is thus (1+0.3)+(1+0.1)=2.4. The latter link thus has its wireless resource consumption of 10×2.4. As a result, the potential path L1 has its wireless resource consumption of 5.2×2.5+10×2.4=37.

The third column shown in FIG. 7 lists wireless resource consumption for each of the potential paths L1 to L15. Note that although the wireless resource consumption is not to be calculated in practice for the potential paths that have already been removed at step S3, FIG. 7 shows, for reference only, the wireless resource consumption for all the potential paths.

In step S5, FIG. 1, the margin of conveyable traffic of a relay node is calculated for each unremoved potential path. The traffic margin of the potential path is then calculated by multiplying the margin of conveyable traffic of all the relay nodes. Alternatively, the minimum of the margin of conveyable traffic at each relay node may be employed as the traffic margin of the potential path.

The potential path L1, for example, has the node BS02 as its single relay node. The potential path L1 thus has its traffic margin equal to the traffic margin 0.5 of the node BS02 when any calculation method is applied.

The potential path L8, for example, has two nodes BS03 and BS05 its relay nodes. The potential path L8 thus has its traffic margin equal to a value of 0.7, which is the lower one, i.e. minimum, of the traffic margin 0.8 of the node BS03 and the traffic margin 0.7 of the node BS05. Note that if the multiplication method is applied, then the traffic margin of the potential path will be 0.7×0.8=0.56.

The fourth column from the left in FIG. 7 shows the traffic margin of the potential paths obtained by selecting the minimum of the traffic margin at each relay node. It is to be noted that although the traffic margin is not to be calculated for the potential paths that have already been removed at step S3, FIG. 7 shows, merely for the purpose of reference, the traffic margin for all the potential paths.

In step S6, FIG. 1, the path is finally selected in two stages. First, the potential paths having the traffic margin thereof relatively smaller are removed or excluded. In FIG. 7, for example, with the traffic margins of 0.5 and 0.6, underlined in the fourth column in FIG. 7, being considered as relatively smaller, the potential paths having traffic margins of 0.5 and 0.6 are removed.

In the example shown in FIG. 7, the exclusion of the potential paths based on the relation between the expected and requested delays and on the traffic margin has caused the potential paths L3, L4, L8 and L13 to L15 to be selected.

After the potential paths are selected or refined as described above, an evaluation value is calculated for each potential path. The potential paths are then ordered in the descending order of the evaluation values. The potential path of the highest order or score is selected as the path for the present requested session.

The evaluation value for the potential paths is a sophisticated value resultant from weighting parameter values, i.e. expected delay, wireless resource consumption and margin of conveyable traffic. The evaluation value may be calculated by making any of the parameter values reciprocal or inverting the sign of any of the parameter values, as needed. For example, the evaluation value may be calculated by the weighted addition of the values resultant from harmonizing the magnitude and applicability of the parameter values, for example, by obtaining the reciprocal of some of the parameter values. Alternatively, for example, the evaluation value may also be provided by ordering values for each parameter, and performing weighted addition on the values in consideration of the order in each parameter.

In short, it is important to define the evaluation value allowing a balanced path to be selected which has lower wireless resource consumption, a larger traffic margin and a smaller expected delay.

The fifth column from the left in FIG. 7 shows the order of the remaining potential paths that are ordered based on the evaluation value. The example shown in FIG. 7 selects the potential path L4 for the requested session having its session ID of 01. More specifically, between the wireless stations BS01 and BS09, communication passes on the path having the wireless station BS08 serving as a relay node.

For example, when the path manager 101 of the wireless station BS01 allocates a path, the path manager 101 of the wireless station BS01 assembles a control packet to provide session information including the communication path and the like to the relaying wireless station BS08 and to the opposite, end wireless station BS09.

As described above, the illustrative embodiment selects a path by taking into account of the expected delay as well as the wireless resource consumption and margin of conveyable traffic, so that the selected path may satisfy the instructed communication quality, minimize the consumption of the limited wireless resources in the wireless mesh network 10, and avoid the traffic concentration on limited ones of the nodes 100. As a result, the session capacity of the entire wireless mesh network 10 may be increased to maximize the throughput.

Although the above-described illustrative embodiment determines a session path by using three parameters, i.e. the expected delay, wireless resource consumption and margin of conveyable traffic, at least one of the wireless resource consumption and margin of conveyable traffic may be used to determine a session path. Thus, the reduction of potential paths may, or may not, be performed according to the wireless resource consumption.

Although the above-described embodiment reduces or refines potential paths based on the expected delay and margin of conveyable traffic, the system may be adapted not to reduce potential paths before the determination according to an evaluation value. Conversely, the potential paths may be reduced to a predetermined number (e.g. five) of paths before the evaluation value is calculated.

Although the above-described embodiment calculates the parameters in the order of the expected delay, wireless resource consumption and margin of conveyable traffic, the parameters may of course be calculated in any other order.

Although the above-described embodiment is structured such that the node or wireless station 100 includes the transmitter and receiver module 110 in single, one node or wireless station 100 may be structured to include a plurality of transmitter and receiver modules 110. Even in the latter case, the path manager 101 may be provided in single to set paths in the similar manner as described above.

For example, a plurality of transmitter and receiver modules may deal at the same time with a plurality of different sessions corresponding to those modules. It is to be noted that links formed between opposing nodes by the respective transmitter and receiver modules different from each other, for example, when each module operates on a separate channel having its carrier frequency or the like different from each other, may be managed as links different from each other in traffic amount, transfer rate and the like, and may be included in different potential paths for a session request. Alternatively, such links may be processed as a single link integrating information on the different channels. For example, when the nodes BS01 and BS02 can communicate on both channels CH1 and CH2, the potential paths in the first column in FIG. 7 may be indicated for each of the channels to provide two potential paths, or alternatively may be dealt with as a single potential path that integrates information on both channels, which will be the same as what is listed in the first column of FIG. 7.

The entire disclosure of Japanese patent application No. 2005-261159 filed on Sep. 8, 2005, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A method for setting a path of a session specified in a wireless mesh network including a plurality of wireless stations, two of the wireless stations being defined as one end and another end of the session, respectively, said method comprising the steps of:
obtaining a potential path for the session based on a number of hops;
calculating, when a plurality of potential paths are obtained, wireless resource consumption for each of the potential paths; and
using the calculated wireless resource consumption as an evaluation parameter to select and set the path of the session.

2. The method in accordance with claim 1, further comprising the step of:
calculating an expected delay at each of the plurality of potential paths; and
using the expected delay as an additional evaluation parameter.

3. A method for setting a path of a session specified in a wireless mesh network including a plurality of wireless stations, two of the wireless stations being defined as one end and another end of the session, respectively, said method comprising the steps of:
obtaining a potential paths for the session based on a number of hops;
calculating, when a plurality of potential paths are obtained, a traffic margin of each of the plurality of potential paths according to a traffic margin of relaying one of the plurality of wireless stations; and
using the calculated traffic margin of the potential paths as an evaluation parameter to select and set the path of the session.

4. The method in accordance with claim 3, further comprising the step of:
calculating an expected delay at each of the plurality of potential paths; and
using the expected delay as an additional evaluation parameter.

5. A method for setting a path of a session specified in a wireless mesh network including a plurality of wireless stations, two of the wireless stations being defined as one end and another end of the session, respectively, said method comprising the steps of:
obtaining a potential path for the session based on a number of hops;
calculating, when a plurality of potential paths are obtained, wireless resource consumption for each of the plurality of potential paths and a traffic margin of each of the plurality of potential paths according to a traffic margin of relaying one of the plurality of wireless stations; and
using the calculated wireless resource consumption and the calculated traffic margin of the potential path as evaluation parameters to select and set the path of the session.

6. The method in accordance with claim 5, further comprising the step of:
calculating an expected delay at each of the plurality of potential paths; and
using the expected delay as an additional evaluation parameter.

7. A wireless station included in a wireless mesh network, comprising a path setting circuit for setting a path of a session specified in the wireless mesh network, two of the wireless stations being defined as one end and another end of the session, respectively, wherein
a potential path is obtained for the session based on a number of hops;
when a plurality of potential paths are obtained, wireless resource consumption is calculated for each of the potential paths; and
the calculated wireless resource consumption is used as an evaluation parameter to select and set the path of the session.

8. The wireless station in accordance with claim 7, wherein said path setting circuit calculates an expected delay at each of the plurality of potential paths, and uses the expected delay as an additional evaluation parameter.

9. The wireless station in accordance with claim 7, further comprising a transmitter and receiver module for communication with another wireless station included in the wireless mesh network.

10. The wireless station in accordance with claim 7, further comprising a plurality of transmitter and receiver modules for communication with at least one other wireless station included in the wireless mesh network.

11. A wireless station included in a wireless mesh network, comprising a path setting circuit for setting a path of a session specified in the wireless mesh network, two of the wireless stations being defined as one end and another end of the session, respectively, wherein
a potential paths is obtained for the session based on a number of hops;
when a plurality of potential paths are obtained, a traffic margin of each of the plurality of potential paths is calculated according to a traffic margin of relaying one of the plurality of wireless stations; and
the calculated traffic margin of the potential paths is used as an evaluation parameter to select and set the path of the session.

12. The wireless station in accordance with claim 11, wherein said path setting circuit calculates an expected delay at each of the plurality of potential paths, and uses the expected delay as an additional evaluation parameter.

13. The wireless station in accordance with claim 11, further comprising a transmitter and receiver module for communication with another wireless station included in the wireless mesh network.

14. The wireless station in accordance with claim 11, further comprising a plurality of transmitter and receiver modules for communication with at least one other wireless station included in the wireless mesh network.

15. A wireless station included in a wireless mesh network, comprising a path setting circuit for setting a path of a session specified in the wireless mesh network, two of the wireless stations being defined as one end and another end of the session, respectively, wherein
a potential path is obtained for the session based on a number of hops;
when a plurality of potential paths are obtained, wireless resource consumption is calculated for each of the plurality of potential paths, and a traffic margin of each of the plurality of potential paths is calculated according to a traffic margin of relaying one of the plurality of wireless stations; and
the calculated wireless resource consumption and the calculated traffic margin of the potential path are used as evaluation parameters to select and set the path of the session.

16. The method in accordance with claim 15, wherein said path setting circuit calculates an expected delay at each of the plurality of potential paths, and uses the expected delay as an additional evaluation parameter.

17. The wireless station in accordance with claim 15, further comprising a transmitter and receiver module for communication with another wireless station included in the wireless mesh network.

18. The wireless station in accordance with claim 15, further comprising a plurality of transmitter and receiver modules for communication with at least one other wireless station included in the wireless mesh network.
